(19) United States
(12) Patent Application Publication
(10) Pub. No.: US 2015/0124818 A1
(43) Pub. Date: May 7, 2015

(54) METHOD FOR TRANSMITTING MEDIA DATA INTERLINKED WITH COMPOSITION INFORMATION AND TRANSMISSION CHARACTERISTICS INFORMATION VIA A HETEROGENEOUS IP NETWORK

(71) Applicant: Electronics and Telecommunications Research Institute, Daejeon (FR)

(72) Inventor: Seong Jun Bae, Daejeon (KR)

(21) Appl. No.: 14/351,818

(22) PCT Filed: Oct. 12, 2012
(86) PCT No.: PCT/KR2012/008351

§ 371 Date: Apr. 14, 2014

(30) Foreign Application Priority Data
Oct. 13, 2011 (KR) 10-2011-0104856
Oct. 12, 2012 (KR) 10-2012-0113653

(51) Int. Cl. H04L 29/06

(52) U.S. Cl. CPC H04L 65/607
USPC 370/392

(57) ABSTRACT

The present invention relates to a method for transmitting media data via a heterogeneous IP network, in which temporal or spatial relationships between MMT assets and transmission characteristics of MMT assets are formed into separate messages in composing MMT assets, thus efficiently transmitting media streaming.

### CROSS-REFERENCE TO RELATED APPLICATION

This application claims priorities to Korean Patent Application No. 10-2011-0104856 filed on Oct. 13, 2011 and Korean Patent Application No. 10-2012-0113653 filed on Oct. 12, 2012, the contents of which are herein incorporated by reference in its entirety.

### TECHNICAL FIELD

The present invention relates to a method of transporting media data and, more particularly, to a method of transporting coded media data in a system for transporting coded media data via a heterogeneous IP network.

### BACKGROUND ART

An MPEG-2 system is a standard for functions such as packetization, synchronization, multiplexing, and the like, required for transmitting audio/video (A/V) contents in a broadcasting network, and an MPEG-2 TS (Transport Stream) technique has been standardized and currently widely used. However, the MPEG-2 TS is ineffective in a new environment in which networks are all adapted for IP (Internet Protocol).

Thus, a novel media transport technique in a system for transporting coded media data via a heterogeneous IP network in consideration of a new media transport environment and an anticipated media transport environment is required.

### DISCLOSURE

### Technical Problem

Therefore, an object of the present invention is to provide a method for transporting media data via a heterogeneous IP network capable of effectively transmitting media streaming by configuring a temporal or spatial relationship between MMT assets, as a separate message in configuring an MMT asset.

Another object of the present invention is to provide a method for transporting media data via a heterogeneous IP network capable of effectively transmitting media streaming by configuring transport characteristics of an MMT asset, as a separate message in configuring an MMT asset.

### Technical Solution

According to an aspect of the present invention, there is provided a method of transporting coded media data in a system for transporting coded media fragment data via a heterogeneous IP network, including: receiving a media unit (MU) having a format independent on a particular media codec from a media codec layer; generating an MMT asset by encapsulating the generated media unit; generating an MMT package by encapsulating the generated MMT asset; generating an MMT payload format upon receiving the generated MMT package; and generating an MMT transport packet upon receiving the generated MMT payload format, wherein the MMT asset includes an MMT asset indicator as an index allowing for the MMT asset to be discriminated from a different MMT asset and an MMT composition information (CI) indicator storing an index of MMT CI referred to by the MMT asset.

The generating of the MMT asset by encapsulating the generated media unit may include generating MMT CI indicating information regarding at least one of the temporary and spatial relationships between MMT assets, and the generating the MMT package by encapsulating the generated MMT asset may be generating an MMT package by encapsulating the generated MMT asset and the MMT CI.

The MMT CI may include the information regarding at least one of the temporal and spatial relationships between MMT assets and the MMT CI indicator as an index allowing the MMT CI to be discriminated from different MMT CI, whereby the MMT asset and the MMT CI maintain relevancy by the MMT CI indicator.

The MMT CI may include a CI header part and a CI data part, and the CI data part may include the information regarding at least one of the temporal and spatial relationships between MMT assets, and the CI header part may include the MMT CI indicator as an index allowing the MMT CI to be discriminated from different MMT CI, whereby the MMT asset and the MMT CI maintain relevancy by the MMT CI indicator.

The MMT asset may further include an indicator indicating the number of the media units stored in the MMT asset.

The MMT asset may include a header part and a data part, the data part may include the media unit, and the header part may include an MMT asset indicator as an index allowing the MMT asset to be discriminated from a different MMT asset and an MMT CI indicator storing an index of MMT CI referred to by the MMT asset.

According to another aspect of the present invention, there is provided a method of transporting coded media data in a system for transporting coded media fragment data via a heterogeneous IP network, including: receiving a media unit (MU) having a format independent on a particular media codec from a media codec layer; generating an MMT asset by encapsulating the generated media unit; generating an MMT package by encapsulating the generated MMT asset; generating an MMT payload format upon receiving the generated MMT package; and generating an MMT transport packet upon receiving the generated MMT payload format, wherein the MMT asset includes an MMT asset indicator as an index allowing for the MMT asset to be discriminated from a different MMT asset and an MMT transport characteristics (TC) indicator storing an index of MMT TC referred to by the MMT asset.

The generating of the MMT asset by encapsulating the generated media unit may include generating MMT TC indicating information regarding transmission of the MMT asset, and the generating the MMT package by encapsulating the generated MMT asset may be generating an MMT package by encapsulating the generated MMT asset and the MMT TC.

The MMT TC may include the information regarding transmission of the MMT asset and the MMT TC indicator as an index allowing the MMT TC to be discriminated from different MMT TC, whereby the MMT asset and MMT TC maintain relevancy by the MMT TC indicator.

The MMT TC information may include a TC header part and a TC data part, and the TC data part may include the information regarding transmission of the MMT asset, and the TC header part may include the MMT TC indicator as an index allowing the MMT TC to be discriminated from different MMT TC, whereby the MMT asset and the MMT TC maintain relevancy by the MMT TC indicator.

The MMT asset may further include an indicator indicating the number of the media units stored in the MMT asset.

The MMT asset may include a header part and a data part, the data part may include the media unit, and the header part may include an MMT asset indicator as an index allowing the MMT asset to be discriminated from a different MMT asset and an MMT TC indicator storing an index of MMT TC referred to by the MMT asset.

The MMT asset may further include an MMT TC indicator storing an index of the MMT TC referred to by the MMT asset.

The generating of the MMT asset by encapsulating the generated media unit may include generating MMT TC indicating information regarding transmission of the MMT asset, and the generating the MMT package by encapsulating the generated MMT asset and the MMT CI may be generating an MMT package by encapsulating the generated MMT asset, the MMT CI, and the MMT TC.

The MMT asset may further include an indicator indicating the number of the media units stored in the MMT asset.

The MMT asset may include a header part and a data part, the data part may include the media unit, and the header part may include an MMT asset indicator as an index allowing the MMT asset to be discriminated from a different MMT asset, an MMT CI indicator storing an index of the MMT CI referred to by the MMT asset, and an MMT TC indicator storing an index of MMT TC referred to by the MMT asset.

### Advantageous Effects

In the case of the method for transporting media data via a heterogeneous IP network according to embodiments of the present invention, since a temporal or spatial relationship between MMT assets is configured as a separate message, the structure of the MMT asset can be simplified, thus effectively transmitting media streaming.

In the case of the method for transporting media data via a heterogeneous IP network according to embodiments of the present invention, since transport characteristics of an MMT asset are configured as a separate message in configuring the MMT asset, media streaming can be effectively transmitted.

### DESCRIPTION OF DRAWINGS

FIG. 1 is a conceptual view illustrating an MMT layer structure;

FIG. 2 is a conceptual view illustrating a format of unit information (or data or a packet) used for each layer of the MMT layer structure;

FIG. 3 is a conceptual view of a configuration of an MMT package; and

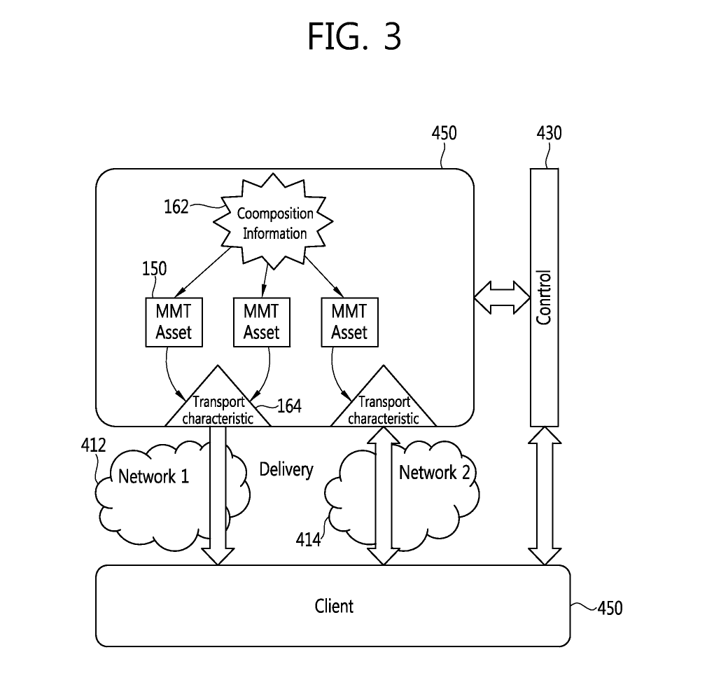

FIG. 4 is a flow chart illustrating a method of transporting coded media divided data according to an embodiment of the present invention.

### BEST MODES

The present invention may be embodied in many different forms and may have various embodiments, of which particular ones will be illustrated in drawings and will be described in detail.

However, it should be understood that the following exemplifying description of the invention is not meant to restrict the invention to specific forms of the present invention but rather the present invention is meant to cover all modifications, similarities and alternatives which are included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component.

When a component is mentioned as being “connected” to or “accessing” another component, this may mean that it is directly connected to or accessing the other component, but it is to be understood that another component may exist therebetween. On the other hand, when a component is mentioned as being “directly connected” to or “directly accessing” another component, it is to be understood that there are no other components in-between.

In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

The terminology used herein is for the purpose of describing particular embodiments only and is not intended to be limiting of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

Hereinafter, terms are defined to have meanings as follows.

A system for transporting coded media data via a heterogeneous IP network is referred to as an MMT (MPEG Media Transport) system.

A content component or media component is defined as a single type of media or a subset of a single type of media, and may be, for example, a video track, movie subtitles, or an enhancement layer of video.

Content is defined as a set of content components, and may be, for example, movie, song, and the like.

Presentation is defined as an operation performed one or more devices to allow a user to experience one or content component or service (e.g., seeing movie).

Service is defined as one or more content components transmitted for representation or storage.

Service information is defined as meta data describing one service and characteristics and components of the service.

Access unit (AU) is the smallest data entity, having time information as an attribute.

When coded media data without designated time information for decoding and presentation is related, AU is not defined.

MMT asset is a logical data entity configured as at least one MPU along with the same MMT asset ID or configured as a particular data mass together with a format defined in a different standard. The MMT asset is the largest data to which the same composition information and transport characteristics are applied.

MMT asset delivery characteristics MMT-ADC is description related to a QoS request for delivering an MMT asset. MMT-ADC is expressed such that a particular transmission environment cannot be known.

MMT composition information (MMT CI) describes spatial and temporal relationships between MMT assets.

A media fragment unit (MFU) is a general container, which is independent to any particular codec and accommodates coded media data that can be independently consumed by a media decoder. The MMT CI, having a size smaller than or equal to an AU, accommodates information that can be used in a transport layer

MMT package is a collection of logically structured data, which is comprised of at least one MMT asset, MMT-composition information, MMT-asset transport characteristics, and descriptive information.

MMT packet is a data format generated or consumed by an MMT protocol.

The MMT payload format is a format for an MMT package to be transferred by an MMT protocol or an Internet application layer protocol (e.g., an RTP), or payload of an MMT signaling message.

Media processing unit (MPU) is a general container independent to any particular media codec, which accommodates information related to at least one AU and additional transmission and consumption. For non-timed data, MPU accommodates a part of data not belonging to an AU range. The MPU is coded media data that can be completely and independently processed. In this context, processing refers to encapsulation or packetization into an MMT package for a transmission.

Non-timed data defines every data element consumed without specified time. Non-timed data may have a time range in which data may be executed or started.

Timed data defines a data element related to a particular time for decoding and presentation.

Media data refers to a data element including non-timed data and timed-data.

Media unit refers to a container including a media fragment unit (MFU) or a media processing unit (MPU).

Hereinafter, embodiments of the present invention will be described in detail with reference to the accompanying drawings. In describing embodiments of the present invention, the same reference numbers are used for the same elements for overall understanding, and a repeated description of the same elements will be omitted.

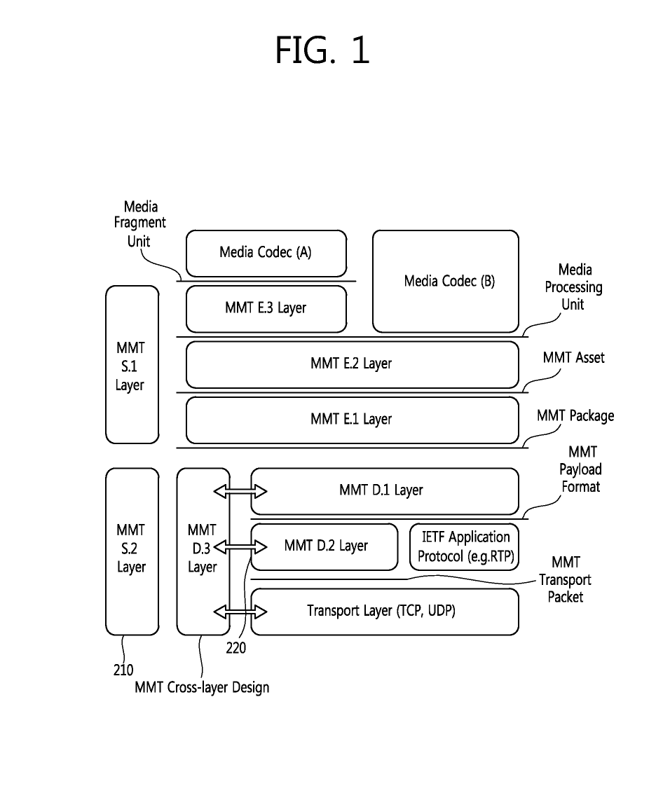

FIG. 1 is a conceptual view illustrating an MMT layer structure.

Referring to FIG. 1, an MMT layer includes an encapsulation layer, a delivery layer, and an S layer. The MMT layer operates above a transport layer.

The encapsulation layer (E-layer) may serve to perform functions, for example, such as media packetization, fragmentation, synchronization, multiplexing, and the like.

The encapsulation functional area defines a logical structure of a format of data units to be processed by an entity that follows MMT, an MMT package, and media contents. In order to provide information essential for adaptive transmission, an MMT package specifies components including media contents and a relationship therebetween. A format of data units is defined to encapsulate coded media such that it is stored or transmitted in payload of a transport protocol and such that it is easily converted therebetween.

As illustrated in FIG. 1, the E-layer may be comprised of an MMT E.1 layer, an MMT E.2 layer, and an MMT E.3 layer.

The E.3 layer generates a media processing unit (MPU) by encapsulating a media fragment unit (MFU) provided from a media codec A layer.

Coded media data from a higher layer is encapsulated into an MFU. A type and a value of coded media may be abstracted such that an MFU can be generally used in a particular codec technique. It allows a lower layer to process an MFU without accessing encapsulated coded media. The lower layer retrieves requested coded media data from a network or a buffer of a repository and transmits it to a media decoder. An MFU has an information media part unit sufficient for performing the operation.

An MFU may have a format that may include a data unit which may be independently consumed in a media decoder and is independent to a particular codec. An MFU may be, for example, a picture or a slice of a video.

One or a group of a plurality of MFUs that can be independently transmitted or decoded generate(s) an MPU. Non-timed media that can be independently transmitted and executed may also generate an MPU. An MPU describes an internal structure such as an arrangement and a pattern of MFUs allowing for a fast access to an MFU and partial consumption.

The E.2 layer generates an MMT asset by encapsulating the MPU generated in the E.3 layer.

The MMT asset, a data entity comprised of one or a plurality of MPUs from a single data source, is a data unit having defined composition information (CI) and transport characteristics (TC). The MMT asset is multiplexed by an MMT payload format and transmitted by an MMT protocol. The MMT asset may correspond to a PES (packetized elementary streams). For example, the MMT asset may correspond to video, audio, program information, an MPET-U widget, a JPEG image, an MPEG 4 file format, an M2TS (MPEG transport stream), and the like.

The E.1 layer generates an MMT package by encapsulating the MMT assent generated by the E.2 layer.

The MMT asset is packaged with MMT composition information (MMT-CI) for a later response of the same user experience separately or together with other functional areas, i.e., a transmission area and a signal area. The MMT package is also packaged together with transport characteristics for selecting an appropriate transmission method for each MMT asset in order to satisfy quality of experience of an MMT asset.

An MMT package may be comprised of one or a plurality of MMT assets together with additional information such as composition information and transport characteristics. Composition information may include information regarding a relationship between MMT assets, and when one content is comprised of a plurality of MMT packages, it may further include information indicating a relationship between the plurality of MMT packages. Transport characteristics may include delivery characteristics information required for determining a delivery condition of an MMT asset or an MMT packet. For example, the transport characteristics may include a traffic description parameter and a QoS descriptor. The MMT package may correspond to a program of an MPEG-2 TS.

The delivery layer may perform, for example, network flow multiplexing, network packetization, QoS controlling, and the like, of media transmitted via a network.

A delivery functional area defines an application layer protocol and a format of payload. In an embodiment of the present invention, an application layer protocol provides characteristics strengthened to delivery an MMT package, in comparison to the related art application layer protocol for transmission of multimedia including multiplexing. A payload format is defined to deliver coded media data without distinction of a media type or an encoding method.

As illustrated in FIG. 1, a delivery layer (D-layer) may be comprised of an MMT D.1 layer, an MMT D.2 layer, and an MMT D.3 layer.

The D.1 layer generates an MMT payload format upon receiving an MMT package generated in the E.1 layer. The MMT payload format is a payload format for transmitting an MMT asset and transmitting information for consumption according to an MMT application protocol or a different existing application transport protocol such as an RTP. The MMT payload may include a fragment of an MFU together with information such as an AL-FEC.

The D.2 layer generates an MMT transport packet or an MMT packet upon receiving an MMT payload format generated in the D.1 layer. The MMT transport packet or the MMT packet is a data format used for an application transport protocol for an MMT.

The D.3 layer supports QoS by providing a function for exchanging information between layers by a cross-layer design. For example, the D.3 layer may perform QoS control by using a QoS parameter of an MAC/PHY layer.

The S layer performs a signaling function. For example, the S layer may perform a signaling function for a session initialization/control/management of transmitted media, a server-based and/or client-based trick mode, service discovery, synchronization, and the like.

A signaling functional area defines a format of a message for managing delivery and consumption of an MMT package. The message for consumption management may be used to transmit a structure of an MMT package and a message for a delivery management is used to transmit a structure of a payload format and a configuration of a protocol.

As illustrated in FIG. 1, the S layer may be comprised of an MMT S.1 layer and an MMT S.2 layer.

The S.1 layer may perform service discovery, media session initialization/termination, media session presentation/control, an interface function with a delivery (D) layer and E layer, and the like. The S.1 layer may define formats of control messages between applications for a presentation session management.

The S.2 layer may define a format of a control message exchanged between delivery end-points of a D layer regarding flow control, delivery session management, delivery session monitoring, error control, and hybrid network synchronization control.

In order to support an operation of a delivery layer, the S.2 layer may include delivery session establishment and release, delivery session monitoring, flow control, error control, resource reservation with respect to a set delivery session, signaling for synchronization under a composite delivery environment, and signaling for adaptive delivery. The S.2 layer may provide signaling required between a sender and a receiver. Namely, the S.2 layer may provide signaling required between a sender and a receiver in order to support an operation of a delivery layer as mentioned above. Also, the S.2 layer may serve to perform an interface function with a delivery layer and an encapsulation layer.

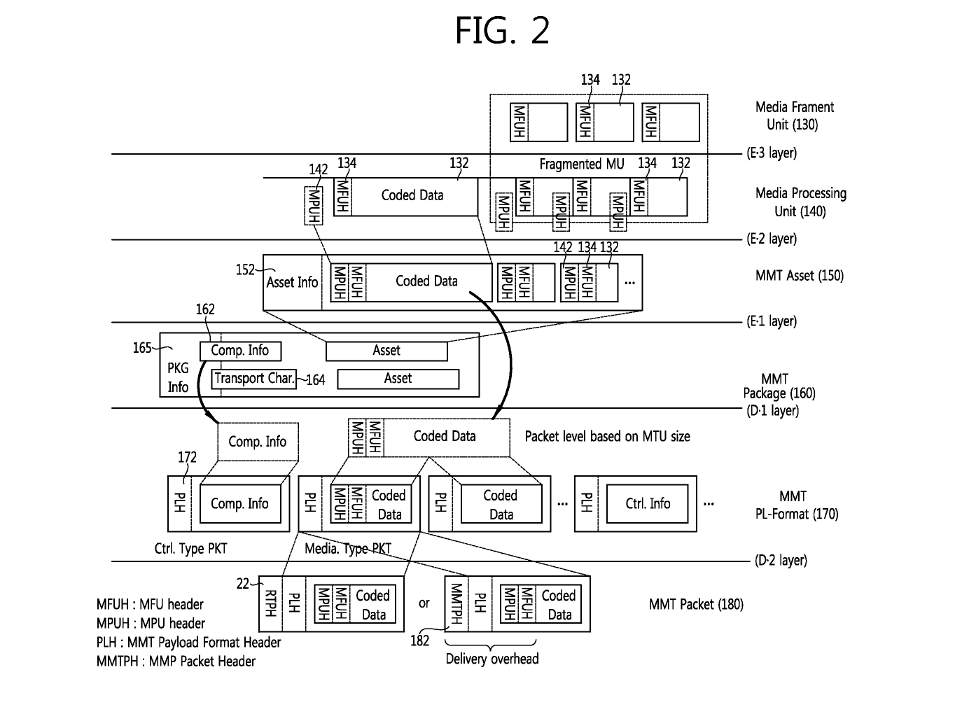

FIG. 2 is a conceptual view illustrating a format of unit information (or data or a packet) used for each layer of the MMT layer structure in FIG. 1;

A media fragment unit (MFU) 130 may include a coded media fragment data 132 and an MFUH (Media Fragment Unit Header) 134. The media fragment unit 130, independent on a particular codec, may have a general container format and include the smallest data unit that can be independently consumed in a media decoder. The MFUH 134 may include additional information such as media characteristics, e.g., loss tolerance. The MFU 130 may be a picture or a slice of a video.

The MFU 130 may define a format for encapsulating a part of an AU in a transport layer in order to perform adaptive transmission within a range of the MFU. The MFU may be used to transmit a certain format of coded media such that a part of an AU may be independently decoded or discarded.

The MFU 130 may have an identifier for discriminating one MFU from other MFUs and have general relationship information between MFUs in a single AU. A dependency relationship between MFUs in a single AU is described, and relevant priority of MFUs may be described as a part of such information. The information may be used to handle transmission in a lower transport layer. For example, a transport layer may omit transmission of MFUs that may be discarded, in order to support QoS transmission in an insufficient bandwidth. Details of the MFU structure will be described later.

An MPU 140 is a set of media fragment units including a plurality of media fragment units 130. The MPU 140 may have a general container format independent on a particular codec, and may include media data equivalent to an access unit. The MPU 140 may have a timed data unit or a non-timed data unit.

The MPU 140 may be a data independently and completely processed by an entity that follows MMT, and the processing may include encapsulation and packetization. The MPU 140 may include at least one MFU or have a part of data having a format defined by a different standard.

A single MPU 140 may accommodate an integral number of at least one AU or non-timed data. For timed data, the AU may be delivered from at least one MFU, but one AU may not be fragmented into a plurality of MPUs. In non-timed data, one MPU accommodates a part of non-timed data independently and completely processed by an entity that follows MMT.

An MPU may be uniquely identified in an MMT package by a sequence number and an associated asset ID discriminating the MPU from a different MPU.

An MPU may have at least one random access point. A first byte of an MPU payload may start by a random access point all the time. In timed data, the foregoing fact means that decoding order of a first MFU in MPU payload is always 0. In timed data, a presentation time and decoding order of each AU may be sent to inform about a presentation time. An MPU may not have an initial presentation time thereof and a presentation time of a first AU of one MPU may be described in composition information. The composition information may specify a first presentation time of an MPU. Details thereof will be described later.

An MMT asset 150 is a set of a plurality of MPUs. The MMT asset 150 is a data entity comprised of a plurality of MPUs (timed or non-timed data) from a single data source, and MMT asset information 152 includes asset packaging metadata and additional information such as a data type. The MMT asset 150 may include, for example, video, audio, program information, an MPEG-U widget, a JPEG image, an MPEG 4 FF (File Format), PES (packetized elementary streams), an M2TS (MPEG transport stream), and the like.

The MMT asset is a logical data entity for accommodating coded media data. The MMT asset may be comprised of an MMT asset header and coded media data. The coded media data may be an aggregational reference group of MPUs with the same MMT asset ID. A type of data that may be individually consumed by an entity directly connected to an MMT client may be considered to be an individual MMT asset. Examples of data types that may be considered to be an individual MMT asset may include MPEG-2 TS, PES, MP4 file, MPEG-U Widget Package, JPEG file, and the like.

Coded media of an MMT asset may be timed data or non-timed data. Timed data is audio visual media data requiring synchronized decoding and presentation of particular data at a designated time. Non-timed data is a type of data that may be decoded at a certain time according to providing of a service or a user interaction and provided.

A service provider may generate a multimedia service by integrating MMT assets and placing the integrated MMT assets in a space-time axis.

An MMT package 160 is a set of MMT assets including one or more MMT assets 150. MMT assets within an MMT package may be multiplexed or concatenated.

The MMT package is a container format for an MMT asset and configuration information. An MMT package provides a repository of the MMT asset and configuration information for an MMT program.

An MMT program provider generates configuration information by encapsulating coded data into MMT assets and describing the MMT assets and a temporal and spatial layout of transport characteristics thereof. An MU and MMT asset may be directly transmitted by a D.1 payload format. The configuration information may be transmitted by a C.1 presentation session management message. However, an MMT program provider allowing for relay of an MMT program or re-use later and a client may store the message in an MMT package format.

In parsing an MMT package, an MMT program provider determines along which transmission path (e.g., broadcast or broadband) an MMT asset is to be provided to a client. Configuration information in the MMT package is transmitted as a C.1 presentation session management message together with transmission-related information.

Upon receiving the C.1 presentation session management message, the client knows which MMT program is available and how the MMT asset for a corresponding MMT program is to be received.

The MMT package may also be transmitted by a D.1 payload format. The MMT package is packetized by a D.1 payload format and delivered. The client receives the packetized MMT package, configures the entirety or a portion thereof, and here, consumes the MMT program.

Package information 165 of the MMT package 160 may include configuration information. The configuration information may include a list of MMT assets, package identification information, composition information 162, and additional information such as transport characteristics 164. The composition information 162 includes information regarding a relationship between MMT assets 150.

Also, when one content is comprised of a plurality of MMT packages, the composition information 162 may further include information indicating a relationship between the plurality of MMT packages. The composition information 162 may include information regarding a temporal, spatial, and adaptive relationship within the MMT package.

Like information helping transmission and presentation of the MMT package, the composition information in the MMT provides information regarding a spatial and temporal relationship between MMT assets within the MMT package.

An MMT-CI is a descriptive language providing corresponding information by extending HTML5. While HTML5 is designed to describe page-based presentation of text-based contents, the MMT-CI mainly expresses a spatial relationship between sources. In order to support an expression indicating a temporal relationship between MMT assets, the MMT-CI may be extended to have information regarding an MMT asset present in an MMT package like presentation resource, time information for determining transmission and consumption order of an MMT asset, and additional attributes of media elements consuming various MMT assets in HTML5. Details will be described later.

Transport characteristics information 164 includes information regarding transport characteristics, and may provide information required for determining a delivery condition of each MMT asset (or MMT packet). The transport characteristics information 164 may include a traffic description parameter and a QoS descriptor.

The traffic description parameter may include the MFU 130 or bit rate information with respect to the MPU, priority information, and the like. The bit rate information may include, for example, information regarding whether or not an MMT asset is a variable bit rate (VBR) or a constant bit rate (CBR), a guaranteed bit rate with respect to an MFU (or an MPU), and a maximum bit rate with respect to a media fragment unit (MFU). The traffic description parameter may be used for resource reservation between a server, a client, and any other components in a transmission path, and may include, for example, information regarding a maximum size of an MFU (or an MPU) within an MMT asset. The traffic description parameter may be periodically or aperiodically updated.

A QoS describer may include information for controlling QoS, and may include, for example, delay information and loss information. The loss information may include a loss indicator as to whether or not a delivery loss of the MMT asset is allowed or not. For example, when a loss indicator is ‘1’, it may indicate ‘lossless’, and when the loss indicator is ‘0’, it may indicate lossy′. The delay information may include a delay indicator used to discriminate sensitivity of transmission delay of an MMT asset. The delay indicator may indicate whether or not an MMT asset type is conversation, interactive, real time, or non-real time.

One content may include one MMT package. Or, one content may include a plurality of MMT packages.

When one content includes a plurality of MMT packages, composition information or configuration information indicating a temporal, spatial, and adaptive relationship between a plurality of MMT packages may exist within or outside one among MMT packages.

For example, in case of hybrid delivery, some of content components may be transmitted via a broadcast network, and the remainders of the content components may be transmitted via a broadband network. For example, in case of a plurality of AV streams constituting a single multiview service, one stream may be transmitted via a broadcast network and the other stream may be transmitted via a broadband network, and each AV stream may be multiplexed and individually received by and stored in a client terminal. Or, for example, a scenario in which an application software such as widget is transmitted via a broadband network and an AV stream (AV program) is transferred via an existing broadcast network may exist.

In the case of the multiview service scenario and/or widget scenario, the entirety of a plurality of AV streams may become one MMT package, and in this case, one of the plurality of streams may be stored only in one client terminal, storage content may be a part of the MMT package, the client terminal should re-write composition information or configuration information, and the re-written content becomes a new MMT package irrespective of a server.

In the multiview service scenario and/or the widget scenario as mentioned above, each AV stream may become one MMT package, and in this case, a plurality of MMT packages constitute one content are stored in the unit of MMT package in a storage, and composition information or configuration information indicating a relationship between MMT packages is required.

Composition information or configuration information included in one MMT package may refer to an MMT asset within a different MMT package and express the exterior of an MMT package referring to an MMT package in an out-band situation.

Meanwhile, in order to provide information regarding a list of MMT assets 160 provided by a service provider and a path available for transmission of the MMT package 160 to a client terminal, the MMT package 160 may be translated into service discovery information through a control (C) layer, so an MMT control message may include an information table for a service discovery.

A server, which has divided multimedia content into a plurality of segments, allocates URL information to the certain number of plurality of segments, stores URL information with respect to the respective segments in a media information file, and transmits the same to a client.

The media information file may be called by various other names such as an ‘MPD (Media Presentation Description)’, a ‘manifest file’, or the like, according to a standardization instrument that standardizes HTTP streaming. Hereinafter, the media information file will be referred to as a media presentation description and described.

Hereinafter, a cross layer interface (CLI) will be described.

A CLI is an interface for exchanging QoS-related information between lower layers including an application layer and a MAC/PHY layer, which provides a means supporting QoS in a single entity. While a lower layer provides bottom-up QoS information such as a network channel state, an application layer provides information related to media characteristics as up-bottom QoS information.

The CLI provides an integrated interface between an application layer and various network layers including IEE802.11 WiFi, IEEE 802.16 WiMAX, 3G, 4G LTE, and the like. Common network parameters of a popular network standard are selected as NAM parameters for static and dynamic QoS control of real-time media application through various networks. The NAM parameter may include a bit error rate value as a BER. The BER may be measured in a PHY or MAC layer. Also, the NAM provides an identifiable bit rate of a lower network, a buffer state, a peak bit rate, a service unit size, and a service data unit loss rate.

Two different methods may be used to provide the NAM. A first method is to provide an absolute value. A second method is to provide a relative value. The second method may be used for updating the NAM.

The application layer provides downward QoS information related to media characteristics with respect to a lower layer. Two types of downward information such as an MMT asset level information and packet level information exist. The MMT asset information is used to exchange capacity and/or (re)allocate resource in a lower layer. Packet level downward information is recorded in an appropriate field of every packet for a lower layer in order to discriminate supported QoS level.

The lower layer provides upward QoS information to the application layer. The lower layer provides information which allows for fast and accurate QoS control and is related to a network state changing over time. The upward information is expressed in an abstracted form to support a heterogeneous network environment. Such parameters are measured in a lower layer and read in an application layer periodically or according to a request from an MMT application.

Hereinafter, an indicator indicating information that may be provided by a media encoder in relation to media data in a system for transmitting coded media data via a heterogeneous IP network will be described.

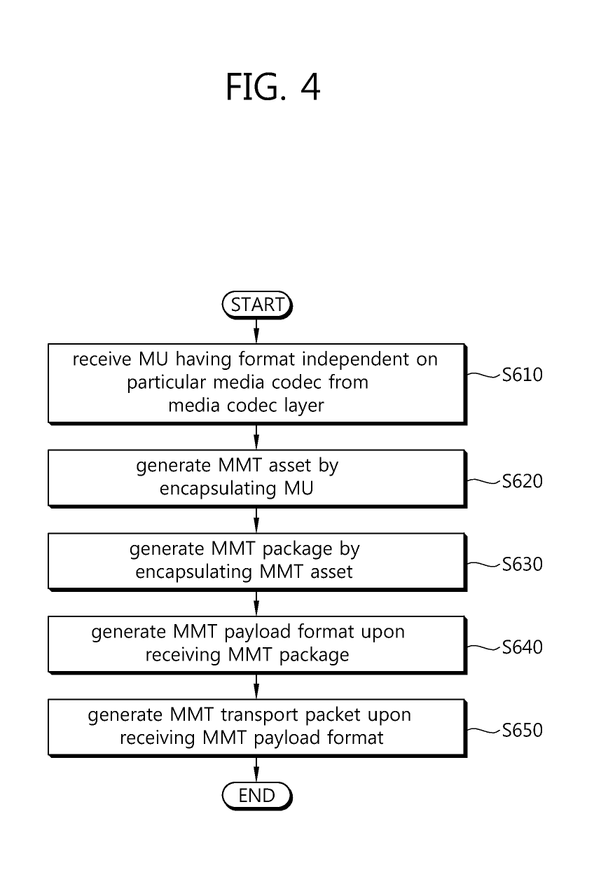

FIG. 4 is a flow chart illustrating a method of transporting coded media divided data according to an embodiment of the present invention. A method of transporting coded media fragment data via a heterogeneous IP network according to an embodiment of the present invention may be performed as illustrated in FIG. 4. According to the method of transporting coded media fragment data according to an embodiment of the present invention, a media unit (MU) having a format independent on a particular media codec is received from a media codec layer (S610). The provided media unit is encapsulated to generate an MMT asset (S620). As mentioned above, the MMT asset is encapsulated to generate an MMT package (S630), an MMT payload format is generated upon receiving the MMT package (S640), and an MMT transport packet is generated upon receiving an MMT payload format (S650).

The MMT asset according to an embodiment of the present invention is configured as a bundle of media units, and is a unit having the same MMT composition information (MMT CI) and MMT transport characteristics (MMT TC). An MMT asset according to another embodiment of the present invention may have only any one of the MMT CI and MMT TC.

A structure and relationship among an MMT asset, MMT CI, and MMT TC will be described. MMT CI and the MMT TC have a format different from that of an MMT asset, and are packaged together with one or more MMT assets on an MMT package level. The MMT CI has a unique index, and an MMT asset is related to the MMT CI referred to by the corresponding MMT asset through the index. Similarly, the MMT TC has a unique index, and an MMT asset is related to the MMT TC referred to by the MMT asset through the index.

Table 1 below shows syntax of an MMT asset according to an embodiment of the present invention.

TABLE 1

| | | |
|---|---|---|
| Syntax | No. of bits | Mnemonic |

mmt_asset ( ){

| | | |
|---|---|---|
| asset_index | 16 | uimsbf |
| comp_info_index | 16 | uimsbf |
| tx_char_index | 16 | uimsbf |
| no_of_unit | 16 | uimsbf |
| for(i=0; i<no_of_unit; i++){ | | |

| | | |
|---|---|---|
| unit_byte_offset | 32 | uimsbf |
| unit_byte_size | 32 | uimsbf |

}
for(i=0; i<no_of_unit; i++){

m_unit ( )

}

}

asset_index is a unique indicator as an index discriminating an MMT asset from a different MMT asset. Mutually different MMT assets have different asset_index, respectively. asset_index is used as a basic factor for describing correlation or interdependency between MMT assets in MMT CI.

comp_info_index is a unique indicator as an index discriminating two or more MMT CIs. Mutually different MMT CIs have different comp_info_index, respectively. An MMT asset denotes MMT CI referred to by itself by using the indicator

tx_char_index is a unique indicator as an index discriminating two or more MMT transport characteristics (TC). Different MMT TCs have different tx_char_index, respectively. An MMT asset denotes MMT TC referred to by itself by using the indicator.

no_of_unit indicates the number of media units included in an MMT asset.

Table 2 below shows syntax of MMT CI according to an embodiment of the present invention.

TABLE 2

| | | |
|---|---|---|
| Syntax | No. of bits | Mnemonic |

mmt_asset_composition_info ( ){

| | | |
|---|---|---|
| comp_info_index | 16 | uimsbf |
| comp_data( ) | | |

}

comp_info_index is a unique indicator as an index discriminating two or more MMT CI. Mutually different MMT CIs have different comp_info_index, respectively. An MMT asset denotes MMT CI referred to by itself by using the indicator.

comp_data( ) is a CI data part of MMT CI. The CI data part includes information regarding at least one of temporal and spatial relationships between MMT assets.

Table 3 below shows syntax of MMT TC according to an embodiment of the present invention.

TABLE 3

| | | |
|---|---|---|
| Syntax | No. of bits | Mnemonic |

mmt_asset_tx_characteristic ( ){

| | | |
|---|---|---|
| tx_char_index | 16 | uimsbf |
| tx_char_data( ) | | |

}

tx_char_index is a unique indicator as an index discriminating two or more MMT TCs. Mutually different MMT TCs have different tx_char_index, respectively. An MMT asset denotes MMT TC referred to by itself by using the indicator.

tx_char_data( ) is a data part of MMT TC. The MMT TC data part includes information regarding transmission of the MMT asset.

A process of packetizing an MMT asset, MMT CI, and MMT TC into an MMT package according to an embodiment of the present invention will be described with reference to FIG. 4. An MMT asset according to another embodiment of the present invention may be packetized together with MMT CI or MMT TC into an MMT package.

In the step (S620) of generating an MMT asset by encapsulating the received media unit according to an embodiment of the present invention, the MMT program provider encapsulates the coded data into an MMT asset, and generates an MMT asset and their temporal and spatial layout and their TC.

The MMT program provider inserts at least one of the temporal and spatial relationships between MMT assets into the MMT CI. In this case, the at least one of the temporal and spatial relationships may be inserted into a data part of the MMT CI. After the MMT program provider inserts an index of the MMT CI into the header part of the MMT CI, the MMT program provider inserts the same index as an index of MMT CI index of the MMT asset.

In a similar manner, the MMT program provider inserts TC of an MMT asset into MMT TC. In this case, the TC of the MMT asset may be inserted in to a data part of the MMT TC. After the MMT program provider inserts an index of the MMT TC into the header part of the MMT TC, the MMT program provider inserts the same index as an MMT TC index of the MMT asset.

Thereafter, in the step (S630) of generating an MMT package by encapsulating the MMT asset, the MMT program provider encapsulates the generated MMT asset, the MMT CI and the MMT TC to generate an MMT package, thereby continuing transmission of coded media fragment data.

Thereafter, as mentioned above, the MMT program provider generates an MMT payload format upon receiving the MMT package (S640), and generates an MMT transport packet upon receiving the MMT payload format (S650).

1. A method of transporting coded media data in a system for transporting coded media fragment data via a heterogeneous IP network, the method comprising:
receiving a media unit (MU) having a format independent on a particular media codec from a media codec layer;
generating an MMT asset by encapsulating the generated media unit;
generating an MMT package by encapsulating the generated MMT asset;
generating an MMT payload format upon receiving the generated MMT package; and
generating an MMT transport packet upon receiving the generated MMT payload format,
wherein the MMT asset includes an MMT asset indicator as an index allowing for the MMT asset to be discriminated from a different MMT asset and an MMT composition information (CI) indicator storing an index of MMT CI referred to by the MMT asset.

2. The method of claim 1, wherein the generating of the MMT asset by encapsulating the generated media unit includes generating MT CI indicating information regarding at least one of the temporary and spatial relationships between MMT assets, and
the generating the MMT package by encapsulating the generated MMT asset is generating an MMT package by encapsulating the generated MMT asset and the MMT CI.

3. The method of claim 2, wherein the MMT CI includes the information regarding at least one of the temporal and spatial relationships between MMT assets and the MMT CI indicator as an index allowing the MMT CI to be discriminated from different MMT CI,
whereby the MMT asset and the MMT CI maintain relevancy by the MMT CI indicator.

4. The method of claim 2, wherein the MMT CI includes a CI header part and a CI data part, and the CI data part includes the information regarding at least one of the temporal and spatial relationships between MMT assets, and the CI header part includes the MMT CI indicator as an index allowing the MMT CI to be discriminated from different MMT CI,
whereby the MMT asset and the MMT CI maintain relevancy by the MMT CI indicator.

5. The method of claim 1, wherein the MMT asset further includes an indicator indicating the number of the media units stored in the MMT asset.

6. The method of claim 1, wherein the MMT asset includes a header part and a data part, the data part includes the media unit, and the header part includes an MMT asset indicator as an index allowing the MMT asset to be discriminated from a different MMT asset and an MMT CI indicator storing an index of MMT CI referred to by the MMT asset.

7. The method of claim 1, wherein the MMT asset further includes an MMT TC indicator storing an index of MMT TC referred to by the MMT asset.

8. The method of claim 2, wherein the generating of the MMT asset by encapsulating the generated media unit includes generating MMT TC indicating information regarding transmission of the MMT asset, and the generating the MMT package by encapsulating the generated MMT asset and the MMT CI is generating an MMT package by encapsulating the generated MMT asset, the MMT CI, and the MMT TC.

9. The method of claim 7, wherein the MMT asset further includes an indicator indicating the number of the media units stored in the MMT asset.

10. The method of claim 7, wherein the MMT asset includes a header part and a data part, the data part includes the media unit, and the header part includes an MMT asset indicator as an index allowing the MMT asset to be discriminated from a different MMT asset, an MMT CI indicator storing an index of the MMT CI referred to by the MMT asset, and an MMT TC indicator storing an index of MMT TC referred to by the MMT asset.

11. A method of transporting coded media data in a system for transporting coded media fragment data via a heterogeneous IP network, the method comprising:
receiving a media unit (MU) having a format independent on a particular media codec from a media codec layer;
generating an MMT asset by encapsulating the generated media unit;
generating an MMT package by encapsulating the generated MMT asset;
generating an MMT payload format upon receiving the generated MMT package; and
generating an MMT transport packet upon receiving the generated MMT payload format,
wherein the MMT asset includes an MMT asset indicator as an index allowing for the MMT asset to be discriminated from a different MMT asset and an MMT transport characteristics (TC) indicator storing an index of MMT TC referred to by the MMT asset.

12. The method of claim 11, wherein the generating of the MMT asset by encapsulating the generated media unit includes generating MMT TC indicating information regarding transmission of the MMT asset, and
the generating the MMT package by encapsulating the generated MMT asset is generating an MMT package by encapsulating the generated MMT asset and the MMT TC.

13. The method of claim 12, wherein the MMT TC includes the information regarding transmission of the MMT asset and the MMT TC indicator as an index allowing the MMT TC to be discriminated from different MMT TC,
whereby the MMT asset and MMT TC maintain relevancy by the MMT TC indicator.

14. The method of claim 12, wherein the MMT TC information includes a TC header part and a TC data part, and the TC data part includes the information regarding transmission of the MMT asset, and the TC header part includes the MMT TC indicator as an index allowing the MMT TC to be discriminated from different MMT TC,
whereby the MMT asset and the MMT TC maintain relevancy by the MMT TC indicator.

15. The method of claim 11, wherein the MMT asset further includes an indicator indicating the number of the media units stored in the MMT asset.
